(19) United States
(12) Patent Application Publication
(10) Pub. No.: US 2025/0328711 A1
(43) Pub. Date: Oct. 23, 2025

(54) DETERMINING COMPACT MODEL PARAMETERS FOR MODELLING CMOS DEVICES AT CRYOGENIC TEMPERATURES

(71) Applicant: SEMIWISE LIMITED, Glasgow (GB)

(72) Inventor: Asen ASENOV, Glasgow (GB)

(73) Assignee: SEMIWISE LIMITED, Glasgow (GB)

(21) Appl. No.: 18/870,333

(22) PCT Filed: May 22, 2023
(86) PCT No.: PCT/GB2023/051339

§ 371 Date: Nov. 27, 2024

(30) Foreign Application Priority Data
May 28, 2022 (GB) 2207910.7

(51) Int. Cl. G06F 30/30

(52) U.S. Cl. CPC G06F 30/30

(57) ABSTRACT

The method is directed to determining compact model parameters for modelling CMOS devices at cryogenic temperatures. The method includes: obtaining (110) a room-temperature TCAD model of CMOS devices: fitting (118) a structural parameter of the room-temperature TCAD model to room-temperature measured characteristics of first CMOS devices, to produce a shifted TCAD model: fitting (128) a carrier transport parameter of the shifted TCAD model to cryogenically measured characteristics of the first CMOS devices, to determine a cryogenically-fitted carrier transport parameter; and running (132, 136) a room-temperature TCAD model of CMOS devices using the cryogenically-fitted carrier transport parameter to determine compact model parameters. The method allows measurement data from a ‘non-ideal’ silicon wafer to be used in a TCAD-based cryogenic PDK recentering process, which may also be used to generate target data for the corner transistors in the recentered PDK.

### TECHNICAL FIELD

The present invention is generally in the field of semiconductors. More particularly, the invention is in the field of semiconductor device modeling and in particular methods and systems of determining compact model parameters for modelling CMOS devices at cryogenic temperatures. The invention also relates to associated non-transitory computer-readable media and computer-readable media containing program code. The invention also relates to an associated method of manufacturing integrated circuits and the integrated circuits thus manufactured.

### BACKGROUND ART

Technology Computer Aided Design (TCAD) is used in developing advanced CMOS (Complementary Metal-Oxide-Semiconductor) technology and in achieving reliable performance from circuit designs using semiconductor devices.

Compact transistor models such as BSIM4 (Berkeley Short-channel IGFET Model 4) and BSIM-CMG (Berkeley Short-channel IGFET Model-Common Multi-Gate) are simplified physical models typically employed in circuit simulators, for example SPICE (Simulation Program with Integrated Circuit Emphasis), to model the behavior of semiconductor devices such as CMOS field effect transistors in integrated circuits. The set of compact model parameters that specify the behavior of a particular semiconductor device are stored in a data structure called a model card, which is used as an input to a SPICE simulation process.

There is great interest in cryogenic CMOS design for reducing the power dissipation of data centres at 77K and for interfacing CMOS analogue and digital circuits to the quantum bits (qbits) within the same cryogenic chamber in the temperature range from 77K to 1K and below. The problem is that the semiconductor foundry Process Development Kits (PDKs), which include compact transistor models, are designed for room-temperature operation and no foundry PDKs are available for design at cryogenic temperatures from 77K down to 1K, because the cost of developing a cryogenic PDK is prohibitive. As a compromise, measurements at cryogenic temperatures can be used to re-centre the room-temperature PDK to cryogenic temperatures but there are problems related to this.

However, the conventional use of measurements for the Cryogenic PDK Re-Centring (CPRC) is a complicated process due to discrepancies between the characteristics of the typical-typical (TT) transistors from the foundry PDK and the transistors measured on the silicon chips. The foundry therefore cannot not guarantee to their fabless Integrated Circuit (IC) design customers that the fabricated transistors will have the same characteristics as the TT transistors in the PDK. The foundry may only guarantee that the cryogenic transistor characteristics on the fabricated wafers will be in-between the characteristics of the fast-fast (FF) and slow-slow (SS) transistor characteristics in the PDK.

### SUMMARY

A method for determining compact model parameters for modelling CMOS devices at cryogenic temperatures, substantially as shown in and/or described in connection with at least one of the figures, and as set forth more completely in the claims.

According to a first aspect of the present invention, there is provided a method for execution in at least one processor of at least one computer, the method for determining compact model parameters for modelling CMOS devices at cryogenic temperatures, the method comprising the steps of:
(a) obtaining a room-temperature TCAD model of CMOS devices;
(b) fitting a structural parameter of the room-temperature TCAD model to room-temperature measured characteristics of first CMOS devices, to produce a shifted TCAD model;
(c) fitting a carrier transport parameter of the shifted TCAD model to cryogenically measured characteristics of the first CMOS devices, to determine a cryogenically-fitted carrier transport parameter; and
(d) running a room-temperature TCAD model of CMOS devices using the cryogenically-fitted carrier transport parameter to determine compact model parameters.

Preferably, the step (a) of obtaining a room-temperature TCAD model of CMOS devices comprises fitting structural and carrier transport parameters of a room-temperature TCAD model of CMOS devices to room-temperature simulated characteristics of CMOS devices.

Preferably, the step (d) of running a room-temperature TCAD model of CMOS devices comprises:
using the cryogenically-fitted carrier transport parameters to determine target cryogenic CMOS device characteristics; and
extracting the compact model parameters from the target cryogenic CMOS device characteristics.

Preferably, the structural parameter comprises a parameter selected from the group comprising: simulation domain parameter, region parameter; and doping distribution parameter.

Preferably, the carrier transport parameter comprises a mobility parameter for mobility calibration.

Preferably, the carrier transport parameter further comprises an implant ionisation parameter and/or a band tail parameter, for electrostatic calibration in the step (c) of fitting a carrier transport parameter.

Preferably, a fitted carrier transport parameter of the room-temperature TCAD model is kept constant between step (a) obtaining a room-temperature TCAD model of CMOS devices and step (c) fitting a carrier transport parameter of the shifted TCAD model.

Preferably, the fitted structural parameter of the room-temperature TCAD model is kept constant between step (b) fitting the structural parameter of the room-temperature TCAD model to room-temperature measured characteristics of first CMOS devices and step (d) running a room-temperature TCAD model of CMOS devices.

Preferably, the room-temperature TCAD model of CMOS devices comprises a room-temperature TCAD model of typical-typical (TT) CMOS devices.

According to a second aspect of the present invention, there is provided a non-transitory computer-readable medium containing program code, the program code adapted to configure the at least one processor of the at least one computer to execute the method of the first aspect.

According to a third aspect of the present invention, there is provided a computer-readable medium containing program code, the program code adapted to configure the at least one processor of the at least one computer to execute the method of the first aspect, the computer-readable medium being selected from the group consisting of: a compact disk (CD), a digital video disk (DVD), a flash memory storage device, a hard disk, a random access memory (RAM), and a read only memory (ROM).

According to a fourth aspect of the present invention, there is provided a system for determining compact model parameters for modelling CMOS devices at cryogenic temperatures, the system obtaining measurements from first CMOS devices at room temperature and cryogenically, the measurements being utilized by at least one processor of at least one computer of the system to implement a method for simulating semiconductor devices, the computer configured to perform the steps of:
(a) obtaining a room-temperature TCAD model of CMOS devices;
(b) fitting a structural parameter of the room-temperature TCAD model to room-temperature measured characteristics of first CMOS devices, to produce a shifted TCAD model;
(c) fitting a carrier transport parameter of the shifted TCAD model to cryogenically measured characteristics of the first CMOS devices, to determine a cryogenically-fitted carrier transport parameter;
(d) running a room-temperature TCAD model of CMOS devices using the cryogenically-fitted carrier transport parameter to determine compact model parameters.

According to a fifth aspect of the present invention, there is provided a method of manufacturing integrated circuits for cryogenic operation, the method comprising the steps of:
(a) obtaining a room-temperature TCAD model of CMOS devices;
(b) fitting a structural parameter of the room-temperature TCAD model to room-temperature measured characteristics of first CMOS devices, to produce a shifted TCAD model;
(c) fitting a carrier transport parameter of the shifted TCAD model to cryogenically measured characteristics of the first CMOS devices, to determine a cryogenically-fitted carrier transport parameter;
(d) running a room-temperature TCAD model of CMOS devices using the cryogenically-fitted carrier transport parameter to determine compact model parameters;
(f) using the determined compact model parameters to generate a circuit layout; and
(g) using the circuit layout to pattern a semiconductor substrate to produce an integrated circuit.

According to a sixth aspect of the present invention, there is provided an integrated circuit manufactured using the method of the fifth aspect.

### BRIEF DESCRIPTION OF THE DRAWINGS

Embodiments of the present invention will now be described, by way of example only, with reference to the drawings, in which:

FIG. 1 shows a flowchart illustrating the steps taken to implement an embodiment of the present invention.

FIG. 2 shows room-temperature PDK simulated characteristics of a typical-typical (TT) transistor and fitted TCAD model output data points. For comparison the simulated characteristics of the slow-slow (SS) and the fast-fast (FF) transistors are also plotted.

FIG. 3 shows a comparison between the room-temperature PDK simulated characteristics of the TT transistor from FIG. 2 and the corresponding room-temperature measurement data from a fabricated silicon wafer.

FIG. 4 shows a comparison between the room-temperature measurement data from FIG. 3 and the room-temperature shifted TCAD model output data.

FIG. 5 shows a comparison between the cryogenic (77K) measurement data on a fabricated silicon wafer and cryogenic (77K) output of the shifted and cryogenically-calibrated TCAD model.

FIG. 6 shows a comparison between the cryogenic (77K) target characteristics output from the TCAD model of the TT transistor using the cryogenically-fitted carrier transport parameters, and output from the extracted cryogenically-recentered compact model.

FIG. 7 shows a measurement, simulation and fabrication system for manufacturing integrated circuits in accordance with at least one embodiment of the present invention.

### DETAILED DESCRIPTION OF EMBODIMENTS

The present invention is directed to a method of generating compact model parameters for modelling CMOS devices at cryogenic temperatures. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention.

The drawings in the present application and their accompanying detailed description are directed to merely exemplary embodiments of the invention. To maintain brevity, other embodiments of the present invention are not specifically described in the present application and are not specifically illustrated by the present drawings.

Embodiments allow measurement data from a ‘non-ideal’ silicon wafer to be used in a TCAD-based cryogenic PDK recentering process. Embodiments may also be used to generate target data for the corner transistors in the recentered PDK.

Embodiments provide accurate recentering of room-temperature foundry PDKs to allow design at cryogenic temperatures. Embodiments use a combination of experimental room-temperature and cryogenic measurements of transistors on CMOS test chips and TCAD simulations.

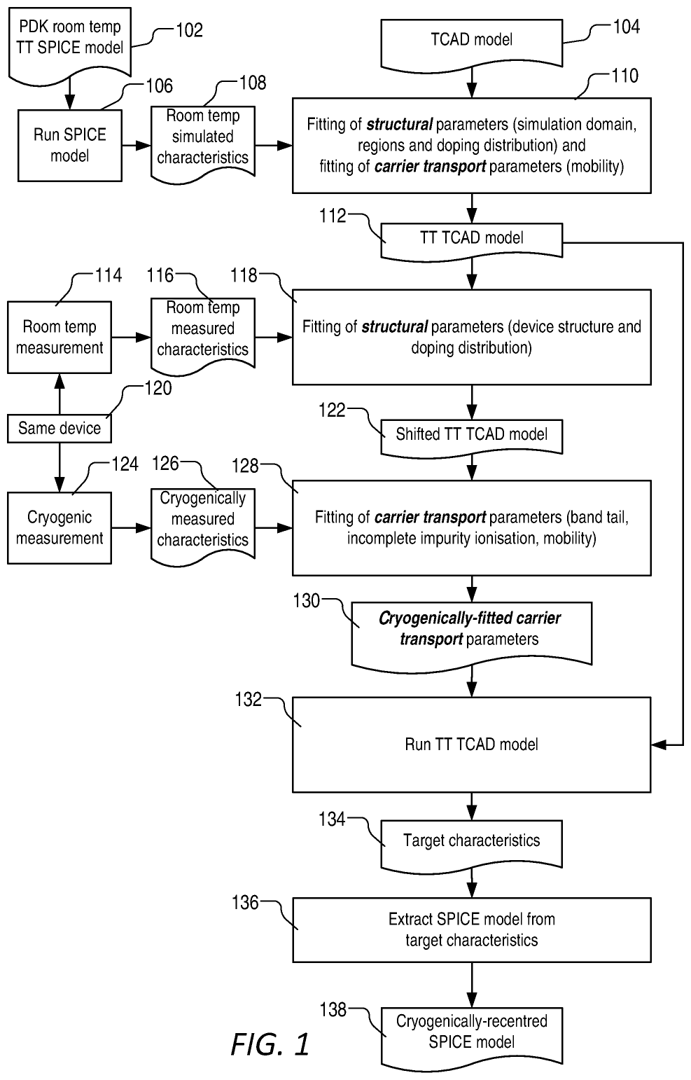

FIG. 1 shows a flowchart illustrating the steps taken to implement an embodiment of the present invention. The method may be executed in at least one processor of at least one computer. The method is directed to determining compact model parameters for modelling CMOS devices at cryogenic temperatures.

The first step 110 involves developing a room-temperature TCAD model 112 of typical-typical (TT) CMOS devices. In this example, this includes fitting structural parameters (e.g. simulation domain, region and doping distribution parameters) and fitting carrier transport parameters (e.g. mobility parameters) of a room-temperature TCAD model 104 of CMOS devices to room-temperature PDK-simulated characteristics 108 of typical-typical (TT) CMOS devices. In other examples, TCAD models of other CMOS devices in the fabrication process parameter space may be used, for example TCAD models of slow-slow (SS) or fast-fast (FF) CMOS devices.

Thus a typical-typical (TT) TCAD model 112 of the typical-typical (TT) transistors is developed 110 from the PDK room-temperature TT SPICE model 102. First, the PDK room-temperature TT SPICE model 102 is run 106 to generate the room-temperature simulated characteristics 108.

Next, fitting structural parameters includes the adjustments of the doping profile and other aspects of the transistor structure to match the electrostatic behaviour of the TT transistors (that are represented by the PDK SPICE model) including the threshold voltage V_{T}, the Subthreshold Slope SS, the Drain Induced Barrier Lowering (DIBL) at different bias conditions and their dependence on the transistor dimensions. This is followed up with fitting mobility parameters. This mobility calibration is performed to accurately represent the transistor performance at low and high drain bias in the developed model. The mobility models are selected to represent as accurately as possible the temperature dependence at cryogenic temperatures.

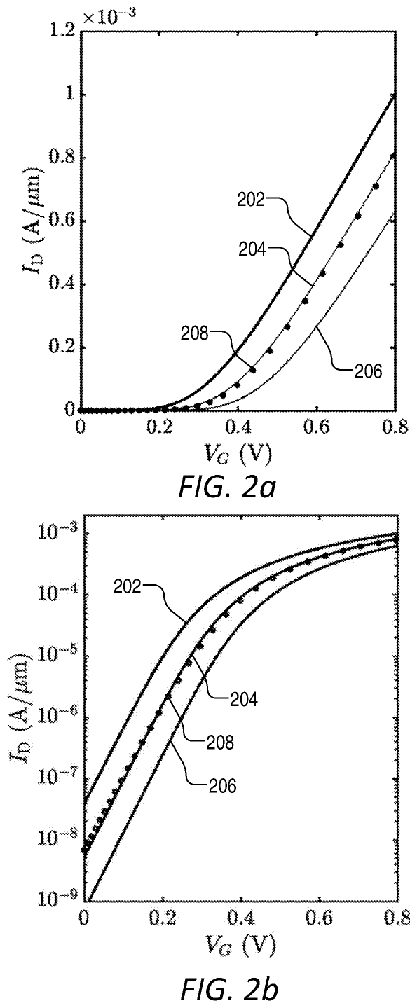

FIG. 2 shows PDK-simulated characteristics of a TT n-channel transistor and fitted TCAD model n-channel output data. In the graphs of FIG. 2 and in subsequent graphs, features labelled with the same numerals correspond to the same features in subsequent graphs. Therefore a description of a feature in any graph should also apply to a feature labelled with the same numeral elsewhere in this description.

In FIG. 2a and the following graphs, the vertical axis is drain current ID per micron and the horizontal axis is gate voltage VG. FIG. 2a has a linear vertical axis. FIG. 2b represents the same data but with a logarithmic vertical axis. Lines represent simulated characteristics 108 generated by the PDK room-temperature TT SPICE model 102. After developing the TT TCAD model 112 by fitting, data points 208 are generated by the developed model 112. It can be seen that the TCAD-generated n-channel points 208 have a good agreement with the n-channel typical-typical (TT) simulated characteristic 208. For comparison the n-channel simulated characteristics of the slow-slow (SS) 206 and the fast-fast (FF) 202 transistors are also plotted.

With reference again to FIG. 1, the next step is 118 is fitting structural parameters of the developed room-temperature TT TCAD model 112 to room-temperature measured characteristics 116 of test TT CMOS devices 120 on a fabricated silicon wafer, measured 114 at room temperature. This fitting produces a shifted TCAD model 122. This shift accounts for the structural differences between the test CMOS devices 120 and typical-typical CMOS devices represented by the developed room-temperature TCAD model 112.

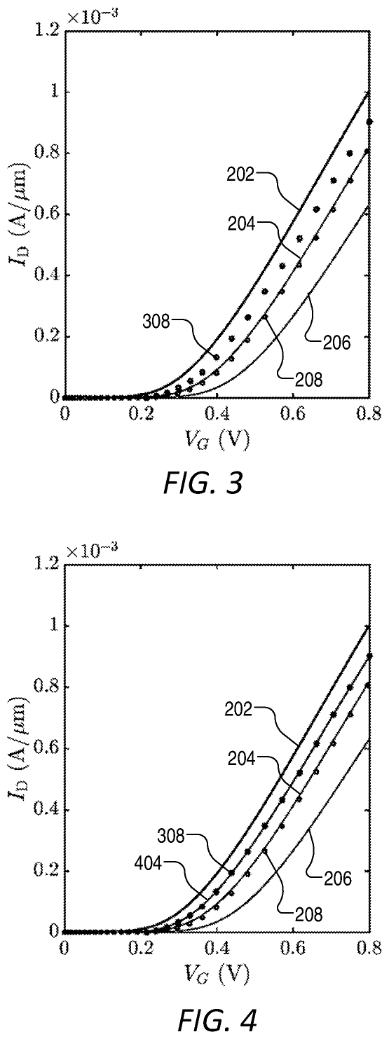

Before we discuss the fitting, with reference to FIG. 3 we consider the room-temperature measured characteristics 116 of test CMOS devices 120 on a fabricated silicon wafer. FIG. 3 shows comparison between the room-temperature simulated characteristics 108, 204 of the TT transistor shown in FIG. 2 and the corresponding room-temperature measured characteristics 116 from test CMOS devices on a fabricated silicon wafer. The n-channel room-temperature measured characteristic is represented by the points 308 in FIG. 3. As expected, the measured points 308 are shifted with respect to the corresponding PDK room-temperature simulated TT transistor characteristic 204 (and therefore the fitted TCAD generated n-channel points 208). That PDK simulated characteristic 204 represents the average transistor characteristics across the wafer, across the lots and from lot to lot. The actual test transistor 120 measured characteristics on each wafer are different from the average transistor characteristics due to uncontrollable variations in the fabrication conditions. The main process parameters that cause such process variation are the dose and energy of different implantations, the gate oxide thickness, the annealing temperatures and the transistor dimensions. Typically, up to 5% variations in these process parameters are expected during the fabrication process.

This step 118 provides shifting of the TCAD model 112 of the TT transistor that was developed earlier to match the room-temperature measured characteristics 116 from test devices 120 on the wafer. For consistent calibration the shifting is achieved by changing the key structural parameters in the TCAD process simulation deck in order to match the measured transistor characteristics without changing the mobility model parameters that were determined by fitting during the TT TCAD model development step 110.

The structural parameter changes may include the dose and energy of different implantations, the gate oxide thickness, the annealing temperatures and the transistor dimensions, within the typical 5% limits. The different structural parameters (also known as process parameters or technology parameters) have different impact on threshold voltage, electrostatic integrity and drive current and are tested and combined to give the desirable shift in transistor behaviour from the TT TCAD model output to the measured transistor. After fitting, the new TCAD deck in the shifted TCAD model 122 will represent shifted TT transistors, which will be used at the next step for the carrier transport calibration at cryogenic temperatures.

Because the room-temperature simulated characteristics 108 and room-temperature measured characteristics 116 are both obtained from room-temperature measurements, the same carrier transport behaviour is expected to underlie each of the characteristics. So, there is no need to adjust carrier transport parameters of the room-temperature TCAD model 112 to fit to the room-temperature measured characteristics 116 of test CMOS devices 120, such as by fitting mobility parameters in this step 118. Thus, carrier transport parameters of the room-temperature TCAD model are kept constant, or at least not fitted to the room-temperature measured characteristics of the first CMOS devices between the step 110 of obtaining a room-temperature TCAD model 112 of typical-typical (TT) CMOS devices and the next step 128 (described below) of fitting carrier transport parameters of the shifted TCAD model.

The results of the calibration are illustrated in FIG. 4, which shows a comparison between the room-temperature measurement data 308 from test devices on a fabricated silicon wafer and the room-temperature output 404 of the shifted TCAD model 122. The room-temperature characteristic 404 output from the shifted TCAD model is shown as a line. There is good agreement between this characteristic 404 and the room-temperature measurement data 308.

This next step, 128 involves fitting carrier transport parameters (e.g. band tail, incomplete impurity ionisation, and/or mobility parameters) of the shifted TCAD model to cryogenically measured characteristics 126 of the test CMOS devices 120, to determine cryogenically-fitted carrier transport parameters (e.g. band tail, incomplete impurity ionisation, and/or mobility parameters). Thus, at this step 128 the shifted TT TCAD model 122 is calibrated to the cryogenic transistor measurements 124, of the same device 120 that was used (with room-temperature measurements) to produce the shifted TT TCAD model 122 itself.

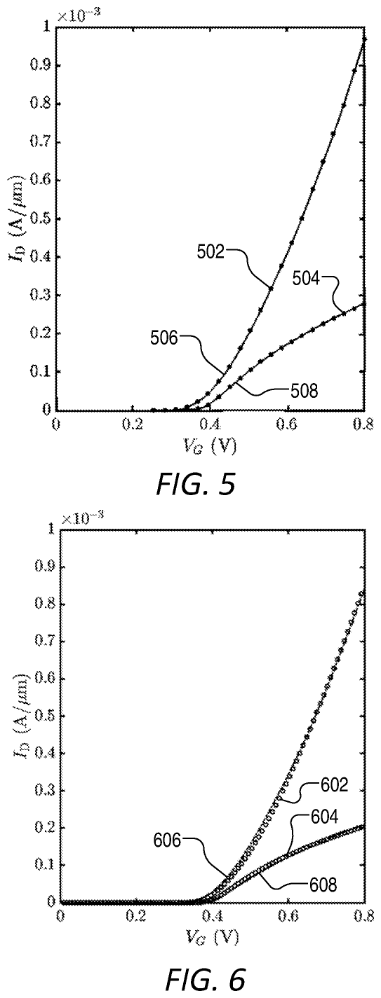

This step 128 includes two parts: electrostatic calibration; and mobility calibration. The electrostatic calibration aims to reproduce V_{T}, Subthreshold Slope SS and DIBL of the shifted TT TCAD model 122 at cryogenic temperatures. As mentioned above, models that can be used to achieve this calibration include incomplete impurity ionisation and the impact of the band tail state on the subthreshold characteristics. The mobility calibration is similar to the calibration procedure 110 at room temperature aiming to reproduce the current voltage characteristics above threshold. The results from the calibration of the shifted TT TCAD model at 77K are illustrated in FIG. 5.

The structural parameters of the room-temperature TCAD model are kept constant or at least not fitted to the cryogenically measured characteristics of the first CMOS devices between the step 118 of fitting a structural parameter of the room-temperature TCAD model to room-temperature measured characteristics of first CMOS devices and the step 132 of running a room-temperature TCAD model 112 of typical-typical (TT) CMOS devices.

With reference to FIG. 5, the cryogenic (77K) measurement data 126 on a fabricated silicon wafer at two different drain biases are shown as points 502, 504 and the cryogenic (77K) output of the shifted and cryogenically-calibrated TCAD model are shown as lines 502, 504 for the respective drain biases.

The next steps 132, 136 involve running a room-temperature TCAD model 112 of typical-typical (TT) CMOS devices using the cryogenically-fitted carrier transport parameters 130 to determine compact model parameters 138. In more detail, the unshifted TCAD model 112 of the TT transistor and the calibrated band tail, incomplete ionisation and mobility models at 77K (i.e. cryogenically-fitted carrier transport parameters 130) can be used to generate the target characteristics 134 for the compact model extraction 136 of the TT transistor at cryogenic temperature.

Thus, the step 132 of running the unshifted room-temperature TCAD model 112 of typical-typical (TT) CMOS devices using the cryogenically-fitted carrier transport parameter to determine compact model parameters may comprise two steps. First, the cryogenically-fitted carrier transport parameters 132 are used to determine target cryogenic CMOS device characteristics 134. Either the same unshifted room-temperature TCAD model 112 may be run, or alternatively another unshifted room-temperature TCAD model (for example a TCAD model, not shown, used to develop the PDK SPICE model 102) may be run at this step. Next, the compact model (SPICE) parameters are extracted 136 from the target cryogenic CMOS device characteristics 134, to produce the cryogenically-recentered compact model 138.

The generated target characteristics 134 and the output from the extracted 77K compact model of the TT transistor are illustrated in FIG. 6, which shows a comparison between the 77K target characteristics 134 output from the TCAD model of the TT transistor using the cryogenically-fitted carrier transport parameters (shown as points 602, 604) and the characteristics generated by the extracted cryogenically-recentered compact model 138, shown as lines 606, 608. Similarly, unshifted TCAD models of the SS and FF corner transistors and the calibrated band tail, incomplete ionisation and mobility models at 77K (i.e. cryogenically-fitted carrier transport parameters) can be used to generate the target characteristics for the compact model extraction of the SS and FF corner transistors at cryogenic temperature.

In the steps described above, the structural parameters may be simulation domain parameters, region parameters, and/or doping distribution parameters.

In the steps described above, the carrier transport parameters may further comprise mobility parameters for mobility calibration. The carrier transport parameters comprise implant ionisation parameters and/or band tail parameters for electrostatic calibration.

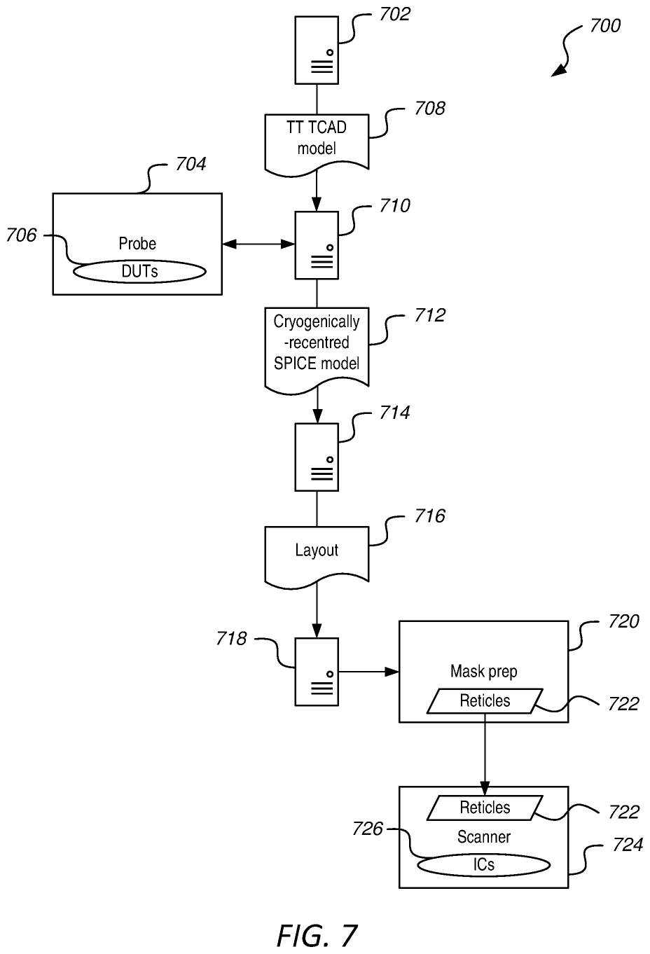

FIG. 7 shows a measurement, simulation and fabrication system for manufacturing integrated circuits in accordance with at least one embodiment of the present invention. The system 700 has measurement at the left, simulation and design in the middle and fabrication at the right.

Computer 702 performs the steps of running the PDK TT SPICE model and fitting TCAD model parameters to the room-temperature fitted characteristics 108 to generate the room-temperature TT TCAD model 112, as described with reference to the steps 106, 110 in FIG. 1. Computer 702 outputs the TT TCAD model 708.

Computer 710, which may control probe system 704, obtains a set of measured data from one or more substrate (typically a semiconductor wafer) under test 706, at room and cryogenic temperatures. The substrate under test 706 includes physical CMOS devices under test (DUTs). As described below, the set of measured data is utilized by at least one processor of at least one computer of the system to implement a method for determining compact model parameters, as described with reference to FIG. 1 to FIG. 6.

The computer 710 obtains the TT TCAD model 702 and performs the TCAD model fitting (room-temperature and cryogenic), model running and compact model extraction, as described with reference to the steps 118, 128, 132, 136 in FIG. 1 and outputs cryogenically-recentered SPICE model parameters 712.

The cryogenically-recentered SPICE model parameters 712 thus generated by computer 710 are received by computer 714. Computer 714 uses the cryogenically-recentered SPICE model parameters in a SPICE simulation as part of the IC design flow. The design process ultimately generates a mask layout 716.

Another computer 718 is used to control a mask-preparation tool 720 using the mask layout 716 to make a set of reticles 722. The reticles 722 are used in a lithography tool, such as a scanner, 724 to pattern a semiconductor substrate 726 to produce integrated circuits on the substrate.

Due to the improved accuracy of the invention's method of determining compact model parameters as described above, the design and/or fabrication of physical semiconductor devices for operation at cryogenic temperatures can be significantly improved. In other words, results obtained from the invention's improved determination of compact model parameters can be utilized to aid engineers in significantly improving the design and/or fabrication of semiconductor circuits and production dies, resulting in an increase in production yield.

It is apparent to one of ordinary skill in the art that the innovative method of the present invention is, at least in some embodiments, implemented by a computer programmed with code to carry on various steps of the present invention's method as described above. Moreover, the code necessary to program such computer can of course be stored in and/or read from any computer-readable medium, such as a compact disk (CD), a digital video disk (DVD), a flash memory storage device, a hard disk, a random access memory (RAM), or a read only memory (ROM), as well as numerous other computer-readable media not specifically mentioned in this application.

From the above description of the invention it is manifest that various techniques can be used for implementing the concepts of the present invention without departing from its scope. Moreover, while the invention has been described with specific reference to certain embodiments, a person of ordinary skill in the art would appreciate that changes can be made in form and detail without departing from the spirit and the scope of the invention. Thus, the described embodiments are to be considered in all respects as illustrative and not restrictive. It should also be understood that the invention is not limited to the particular embodiments described herein but is capable of many rearrangements, modifications, and substitutions without departing from the scope of the invention.

Thus, a method for determining compact model parameters for modelling CMOS devices at cryogenic temperatures has been described.

1. A method for execution in at least one processor of at least one computer, the method for determining compact model parameters for modelling CMOS devices at cryogenic temperatures, the method comprising the steps of:
(a) obtaining a room-temperature TCAD model of CMOS devices;
(b) fitting a structural parameter of the room-temperature TCAD model to room-temperature measured characteristics of first CMOS devices, to produce a shifted TCAD model;
(c) fitting a carrier transport parameter of the shifted TCAD model to cryogenically measured characteristics of the first CMOS devices, to determine a cryogenically-fitted carrier transport parameter; and
(d) running a room-temperature TCAD model of CMOS devices using the cryogenically-fitted carrier transport parameter to determine compact model parameters.

2. The method of claim 1, wherein the step (a) of obtaining a room-temperature TCAD model of CMOS devices comprises fitting structural and carrier transport parameters of a room-temperature TCAD model of CMOS devices to room-temperature simulated characteristics of CMOS devices.

3. The method of claim 1, wherein the step (d) of running a room-temperature TCAD model of CMOS devices comprises:
using the cryogenically-fitted carrier transport parameters to determine target cryogenic CMOS device characteristics; and
extracting the compact model parameters from the target cryogenic CMOS device characteristics.

4. The method of claim 1, wherein the structural parameter comprises a parameter selected from the group comprising: simulation domain parameter, region parameter; and doping distribution parameter.

5. The method of claim 1, wherein the carrier transport parameter comprises a mobility parameter for mobility calibration.

6. The method of claim 1, wherein the carrier transport parameter further comprises an implant ionisation parameter and/or a band tail parameter, for electrostatic calibration in the step (c) of fitting a carrier transport parameter.

7. The method of claim 1, wherein a fitted carrier transport parameter of the room-temperature TCAD model is kept constant between step (a) obtaining a room-temperature TCAD model of CMOS devices and step (c) fitting a carrier transport parameter of the shifted TCAD model.

8. The method of claim 1, wherein the fitted structural parameter of the room-temperature TCAD model is kept constant between step (b) fitting the structural parameter of the room-temperature TCAD model to room-temperature measured characteristics of first CMOS devices and step (d) running a room-temperature TCAD model of CMOS devices.

9. The method of claim 1, wherein the room-temperature TCAD model of CMOS devices comprises a room-temperature TCAD model of typical-typical (TT) CMOS devices.

10. A non-transitory computer-readable medium containing program code, the program code adapted to configure the at least one processor of the at least one computer to execute the method of claim 1.

11. A computer-readable medium containing program code, the program code adapted to configure the at least one processor of the at least one computer to execute the method of claim 1, the computer-readable medium being selected from the group consisting of: a compact disk (CD), a digital video disk (DVD), a flash memory storage device, a hard disk, a random access memory (RAM), and a read only memory (ROM).

12. A system for determining compact model parameters for modelling CMOS devices at cryogenic temperatures, the system obtaining measurements from first CMOS devices at room temperature and cryogenically, the measurements being utilized by at least one processor of at least one computer of the system to implement a method for simulating semiconductor devices, the computer configured to perform the steps of:
(a) obtaining a room-temperature TCAD model of CMOS devices;
(b) fitting a structural parameter of the room-temperature TCAD model to room-temperature measured characteristics of first CMOS devices, to produce a shifted TCAD model;
(c) fitting a carrier transport parameter of the shifted TCAD model to cryogenically measured characteristics of the first CMOS devices, to determine a cryogenically-fitted carrier transport parameter;
(d) running a room-temperature TCAD model of CMOS devices using the cryogenically-fitted carrier transport parameter to determine compact model parameters.

13. A method of manufacturing integrated circuits for cryogenic operation, the method comprising the steps of:
(a) obtaining a room-temperature TCAD model of CMOS devices;
(b) fitting a structural parameter of the room-temperature TCAD model to room-temperature measured characteristics of first CMOS devices, to produce a shifted TCAD model;
(c) fitting a carrier transport parameter of the shifted TCAD model to cryogenically measured characteristics of the first CMOS devices, to determine a cryogenically-fitted carrier transport parameter;
(d) running a room-temperature TCAD model of CMOS devices using the cryogenically-fitted carrier transport parameter to determine compact model parameters;
(f) using the determined compact model parameters to generate a circuit layout; and
(g) using the circuit layout to pattern a semiconductor substrate to produce an integrated circuit.

14. An integrated circuit manufactured using the method of claim 13.

15. The method of claim 2, wherein the step (d) of running a room-temperature TCAD model of CMOS devices comprises:
using the cryogenically-fitted carrier transport parameters to determine target cryogenic CMOS device characteristics; and
extracting the compact model parameters from the target cryogenic CMOS device characteristics.
